(19) United States
(12) Patent Application Publication
(10) Pub. No.: US 2004/0255473 A1
(43) Pub. Date: Dec. 23, 2004

(54) Thin back knife

(76) Inventors: Darren Lamoyne Walton, San Rafael, CA (US); Stephen Anthony Leland, Fairfax, CA (US)

Correspondence Address: Stephen A. Leland, 2300 Sir Francis Drake Boulevard, Fairfax, CA, 94930, US

(21) Appl. No.: 10/463,077

(22) Filed: Jun. 17, 2003

(51) Int. Cl. B26B 9/00

(52) U.S. Cl. 30/346

(57) ABSTRACT

An improved cutting blade on hand-held knives. The blade is thinner at the back than it is at the cutting surface. This blade shape constitutes a knife that cuts without resistance from its sides to the material being cut. This knife gets easier to sharpen the more it is sharpened due to less stock removal the closer the edge gets to the blade back. This knife is inexpensive to manufacture. The blade stock is only as thick as the thickest point of the cutting edge. Once the blade is profiled the only stock removal is at the blade's cutting surface.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Intention

This invention relates to knives, specifically hand-held knives.

2. Background of the Invention

Prior art shows knife blade blanks in four popular blade cross-sections. They are as follows:

a) Flat or V-grind (FIG. 6—25). Both blade sides are flat from the back or top to the edge. A cutting edge is then ground creating a secondary or edge bevel. The thickness of the blade blank and the width or height of the blade determine the angle of the sides as they come down to create the edge. There are problems with this blade cross-section. The blade is thin near the edge and can chip out with hard use and the blade is more difficult to sharpen each time it is sharpened. This is because the amount of stock removed increases the nearer the edge gets to the back. It also forms more of a wedge each time it is sharpened making it difficult to sharpen and making it cut with more resistance or drag from the material being cut.

b) Hollow-ground (FIG. 6—26) is easy to sharpen while the edge is in the hollow of the grind, but forms a wedge once beyond the thinnest part of the blade. This blade needs a thin cross-section to be affective. Thick steel is needed to achieve a wide, thin cross-section. The problems are a weak edge and a thick back. The blade also forms a wedge with repeated sharpening. This makes sharpening and cutting increasingly difficult.

c) Convex-ground (FIG. 6—27) bevels start at the back of the blade and flow to the edge. Enough steel is left above the edge to provide strength. The problems with this blade are that it gets increasingly difficult to sharpen each time it is sharpened. It forms more of a wedge the nearer the edge gets to the back. This also affects its cutting ability because the blade sides are in contact with the material being cut creating resistance.

d) Parallel sided blank (FIG. 6—28) with any of the three aforementioned blade geometry forming the primary bevels. This blade has an edge that gets thick very abruptly and also carries unnecessary weight. It gets difficult to sharpen with repeated sharpening.

To summarize all prior art knives are thicker at the back than at the cutting edge. With repeated sharpening they will always form a wedge. Thin steel can be used to eliminate this problem but the edge is weakened.

### BACKGROUND OF INVENTION —OBJECTS AND ADVANTAGES

Several objects and advantages of this knife are:

a) This blade only contacts the material being cut at the edge. The blade sides offer no resistance to the cut. The blade sides do not press against the sides of the incision of the cut surface.

b) The blade back is thinner than the cutting edge. This blade gives no resistance to the cut because the thicker the blade back is relative to the cutting edge, the more resistance it creates. Conversely, the thinner the blade back is relative to the cutting edge, the less resistance it creates.

c) The blade is easier to sharpen the more it is sharpened. This is because the amount of stock removal diminishes the closer the cutting edge gets to the back.

d) The blade never becomes a wedge with repeated sharpening. It gets thinner and, therefore, easier to sharpen with use.

e) The blade is inexpensive to manufacture because, once the blade is profiled, the only stock removal is in creating the edge.

f) Thinner blade stock is used in manufacturing. The blade stock is only as thick as its cutting edge.

g) The edge is convex ground giving it maximum strength.

### SUMMARY

A back that is measurably thinner than the cutting edge defines this knife. This knife cuts with less resistance from the material being cut. The knife gets easier to sharpen the more it is sharpened. This is because the amount of blade stock removed diminishes as the edge approaches the back. This knife is inexpensive to manufacture because of less stock removal and thinner blade stock is used. The blade stock is only as thick as the thickest point of the cutting edge.

### DRAWINGS—FIGURES

FIG. 1 shows a perspective view of the knife.

FIG. 2 shows a rear perspective view of the knife.

FIG. 3 shows the blade cross-section 9-9.

FIG. 4 is an enlarged sectional view of 9-9 of FIG. 1.

FIG. 5 shows an exaggeration of the blade proportions in FIG. 4 for illustration clarity.

FIG. 6 shows prior art blade cross-sections.

FIG. 7 shows a kindling hatchet using thin back blade geometry.

### DRAWINGS—REFERENCE NUMERALS

| | | | |
|---|---|---|---|
| 9-9 | cross-section of blade | 10 | edge |
| 11 | thickest point of blade | 12 | primary bevel, convex grind |
| 13 | side | 14 | blade back |
| 15 | handle | 16 | blade |
| 25 | V or flat grind blade | 26 | hollow grind blade |
| | cross-section | | cross-section |
| 27 | convex grind blade cross-section | 28 | parallel sided blade |
| | | | cross-section |

Drawings—Reference Numerals Continued

| | | | |
|---|---|---|---|
| 30 | prior art blade back | 31 | prior art blade side |
| 33 | prior art cutting edge | | |

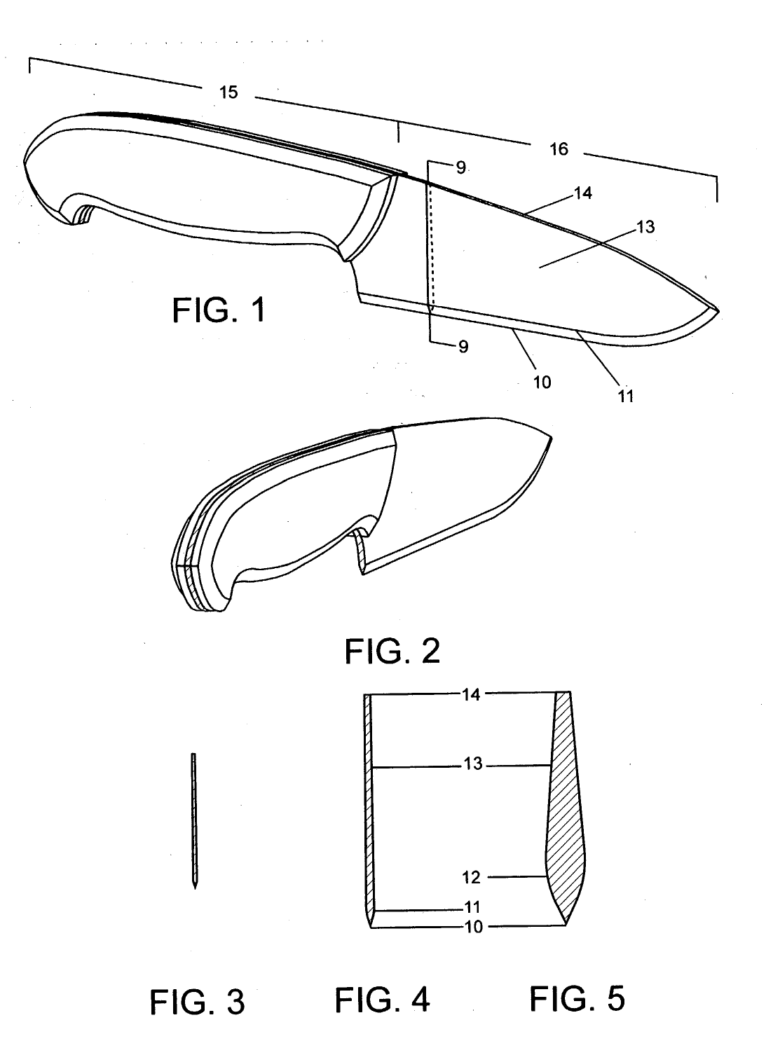

Detailed Description—FIGS. 1 through 5—Preferred Embodiment

FIG. 1 shows a basic version of this knife. The handle 15 and the blade 16 make up this knife. The blade 16 of this knife is thinner at the back 14 than the thickest point 11 of the blade cutting edge 10.

FIG. 2 is a rear view perspective of this knife.

FIG. 3 shows the blade cross-section 9-9.

FIG. 4 shows an enlargement of the cross-section in FIG. 3. A line from the edge 10 to point 11 of the blade makes up the primary bevel 12 (FIG. 5). A line drawn from point 11 to the blade back 14 defines the side of the blade 13. In the finished knife, point 10 is rounded over from the edge to a point on the side 13. This line creates a convex edge 12 (FIG. 5).

FIG. 5 shows an exaggeration of the blade proportions of FIG. 4 for illustration clarity. The back 14 is thinner than the widest point of the cutting edge 12. The widest point of the cutting edge 12 is rounded over forming a convex edge.

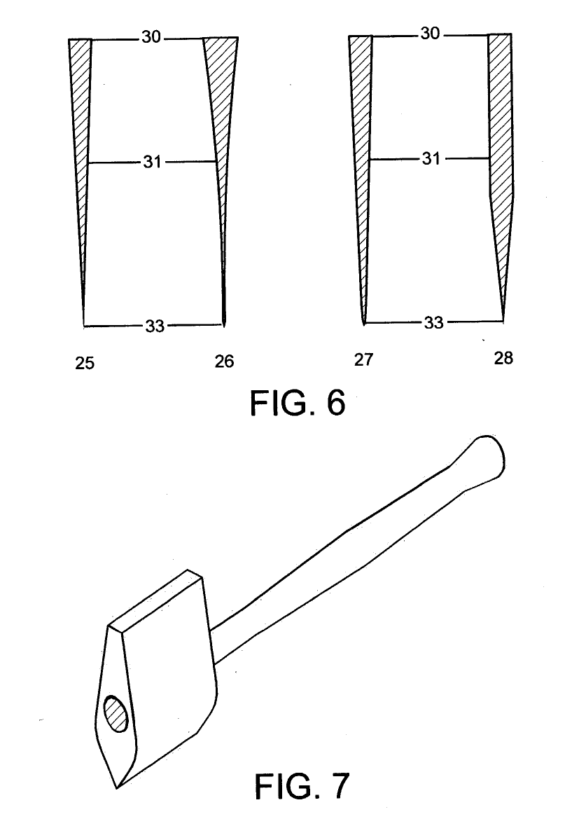

Detailed Description—FIG. 6—Prior Art

FIG. 6 shows four popular blade grinds from prior art knives in cross-section. V-grind 25 the blade sides go straight from the blade back 30 the edge 33. Hollow grind 26 the blades sides 31 go from the back 30 to the cutting edge 33 in a concave line. Convex grind 27 the blade sides 31 go from the blade back 30 to the cutting edge 33 in a convex line. Parallel sided blade 28 the blade cutting edge 33 meets the blade sides 31 below the blade back 30 at the approximate center of the blade.

Detailed Description—FIG. 7—Additional Embodiments

FIG. 7 shows a kindling hatchet using thin back blade geometry.

Advantages

From the description above, a number of advantages of the thin back knife become evident:

a) This blade only contacts the material being cut at the edge. The principle is much like that of a reinforced wire cheese cutter.

b) The blade is easier to sharpen the more it is sharpened due to the diminishing stock removal as the edge approaches the blade back.

c) The blade is inexpensive to manufacture because the blade stock used is only as thick as the widest point of the cutting edge of the tool.

d) The only grinding to be done after the blade is profiled is at the blade's cutting edge.

### CONCLUSION, RAMIFICATIONS, AND SCOPE

Accordingly, the reader will see that the thin back knife will cut with less resistance or friction than prior art knives. The best mode for this knife is food preparation cutlery. This design works well in the kitchen on everything from paring knives to chef's knives and butcher knives.

All hand-held cutlery is improved by this design from hatchets to machetes, from hunting knives to surgical scalpels due to minimum friction and maximum ease of sharpening. The thickness varies proportionately to the lateral strength needed. The thickness also varies depending on strength or durability needed at the edge. Machetes and hatchets are thicker at the edge than kitchen knives and scalpels.

Although the description above contains many specificities, these should not be construed as limiting the scope of the invention but as merely providing illustrations of some of the presently preferred embodiments of this invention. For example, the knife could have a reinforced back to provide both strength and a place to push the blade with the other hand.

Thus the scope of the invention should be determined by the claims and their legal equivalents, rather than by the examples given.

We claim:

1. A hand-held knife comprising:
a) a blade that is thinner at the blade back than at its cutting surface creating less resistance cutting and
b) requires minimum stock removal in its sharpening that lessens with each sharpening and
c) is easier to produce using a minimum amount of blade stock and blade grinding in its manufacture.
